(19) United States
(12) Patent Application Publication
(10) Pub. No.: US 2014/0206312 A1
(43) Pub. Date: Jul. 24, 2014

(54) Mobile telephone with anti-theft function

(71) Applicant: Ching-Fu Chuang, Tainan City (TW)

(72) Inventor: Ching-Fu Chuang, Tainan City (TW)

(21) Appl. No.: 13/694,920

(22) Filed: Jan. 22, 2013

(51) Int. Cl. G08B 13/22

(52) U.S. Cl. CPC G08B 13/22
USPC 455/411

(57) ABSTRACT

This invention is a type of mobile telephone with anti-theft functionality, primarily a mobile telephone with a detection beam emission system inside. The detection beam emission system has a sensor module (e.g. an infrared or human detection device) and a drive unit, and once the anti-theft function is activated, when a person approaches within a certain distance of the place where the mobile phone is placed, it will activate the telephone to emit a sound to attract attention to the person approaching, thereby achieving better anti-theft functionality in a mobile phone in order to protect personal property.

### BACKGROUND OF THE INVENTION

1. Field of the Invention

This invention relates to a type of mobile telephone with anti-theft functionality, more particularly, a type of mobile telephone with anti-theft functionality which, once the anti-theft function is activated, will activate a detection transmitter system when a person approaches, which while activate the mobile phone to emit a noise, thereby achieving the purpose of anti-theft functionality.

2. Description of the Prior Art

Due to shifts in social circumstances, most people now carry mobile phones in order to keep in contact with others. When owners of mobile phones them aside for work, sleep, or other reasons, the fact that owners are asleep, working, or otherwise distracted often allows thieves to gain access to their phones, resulting in significant financial loss. However, the prior art of the mobile phone does not yet have a theft-detection and prevention function. The design of a mobile phone with a theft detection and prevention function can bring people greater security while also increasing the added value of mobile phones, providing mobile phone businesses with an additional selling point.

### SUMMARY OF THE INVENTION

The primary purpose of this invention is to provide a mobile telephone that, once the theft-production function is activated, when someone approaches, the detection beam emission system will activate the mobile phone to emit a sound notifying the owner of the mobile phone that someone has approached, when while also deterring the person approaching the phone from stealing the mobile phone or other valuables.

The main characteristics of the invention is the detection beam emission system installed inside which allows it to be linked to the mobile telephone, and any button on the mobile phone can be assigned to activate, which detection beam emission system is comprised of a sensor module and a drive unit, the sensor module is controls the activation of the drive unit, which in turn is linked to the mobile telephone' ringtone.

### BRIEF DESCRIPTION OF DRAWINGS

This invention is better understood by referring to the accompanying drawings, wherein:

FIG. 1 is a block diagram of the mobile telephone with anti-theft function in the present invention; and

FIG. 2 is a perspective view of the mobile telephone with anti-theft function in using condition in the present invention.

### DETAILED DESCRIPTION OF THE PREFERRED EMBODIMENT

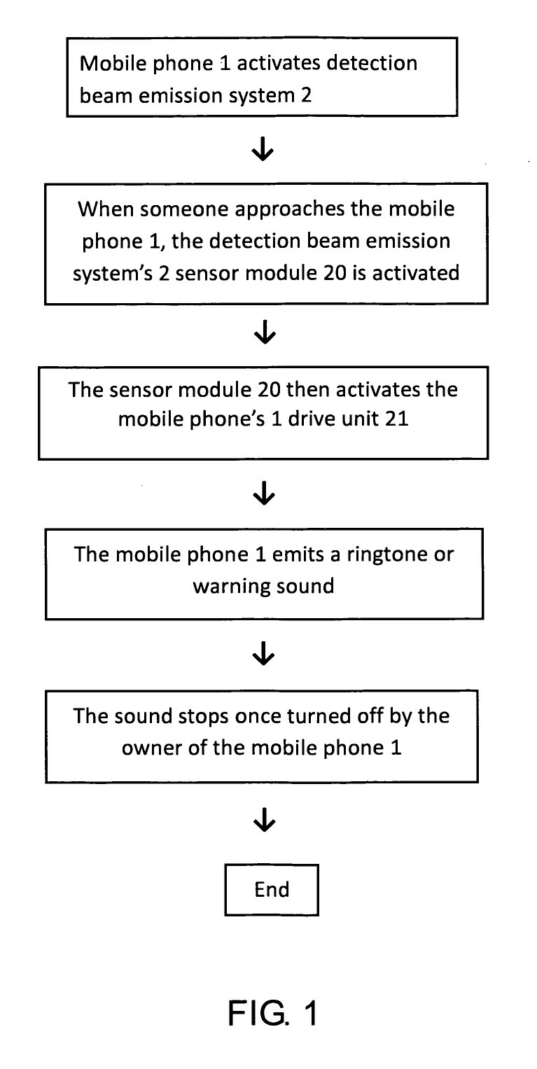

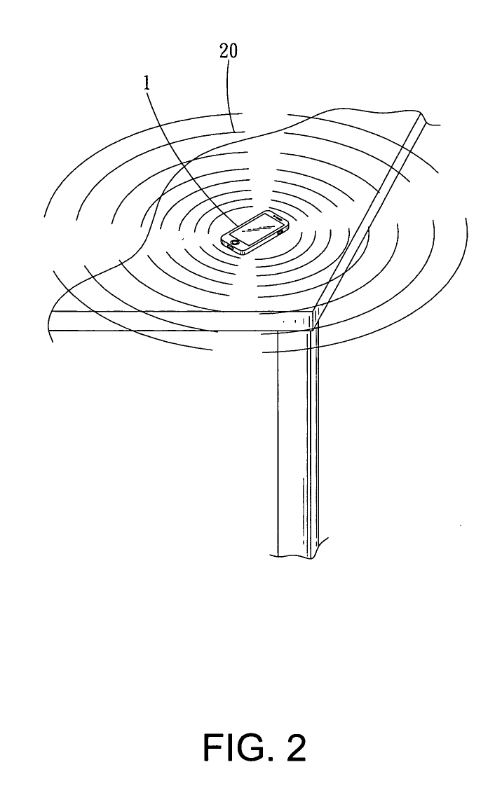

A preferred embodiment of a mobile telephone with anti-theft function in the present invention, as shown in FIGS. 1 to 2.

The detection beam emission system 2 is interconnected with the mobile phone 1, and the detection beam emission system 2 is equipped with a sensor module 20 (e.g. an infrared or human detection device) and a drive unit 21 activating the mobile phone 1 ringtone or alert sound. The activation of the detection beam emission system 2 can be assigned to any button on the mobile phone 1, while the drive unit 21 is controlled by the sensor module 20. As a result, when the sensor module 20 receives sensory input, it will simultaneously activate the drive unit 21, causing the drive unit 21 to activate the mobile phone 1 ringtone or alert sound. The sensor module 20 can be set by the user.

When in use, after the mobile phone 1 is placed on a tabletop, the user can press a button to activate the detection beam emission system 2. At this time, when another person approaches to within the sensing range of the mobile phone's 1 sensor 20, it will emit a ringtone or alert sound, alerting the owner of the mobile phone 1 that someone is approaching it, while also deterring others from approaching the tabletop on which the mobile phone 1 is placed, thereby achieving an anti-theft function. The invention has the following advantages as can be seen from the foresaid description.

1. The invention is installed directly inside the mobile phone 1, and therefore will not result in inconvenience to the user.

2. The invention can achieve the purpose of theft prevention, as once the mobile phone 1 anti-theft function is activated, it will activate the detection beam emission system 2 when someone approaches, preventing others from stealing the mobile phone 1 or other valuables quietly and unnoticed. This is because once someone approaches the mobile phone 1, the sensor module 20 is activated, causing the drive unit 21 to emit a ringtone or alert sound directly from the mobile phone 1, warning others in order to prevent the occurrence of theft.

3. This invention can also be used to alert the user to unwanted entry. When someone intrudes in a room or residence, it will emit a sound to notify the mobile phone 1 user and warn the intruder, thereby achieving the purpose of warning of and preventing theft.

While the preferred embodiment of the invention has been described above, it will be recognized and understood that various modifications may be made therein and the appended claims are intended to cover all such modifications that may fall within the spirit and scope of the invention.

What is claimed is:

1. A mobile telephone with anti-theft functionality, primarily comprising a mobile telephone with a detection beam emission system installed inside which allows it to be linked to the mobile telephone, with any button on the mobile phone able to be used to activate the detection beam emissions system, which is comprised of a sensor module and a drive unit, the sensor module is controls the activation of the drive unit, which in turn is linked to the mobile telephone ringtone.

2. The mobile telephone with anti-theft functionality as claimed in claim 1, wherein said sensor module being an infrared or human detection device, allowing for greater convenience of use.
